(19) United States
(12) Patent Application Publication
(10) Pub. No.: US 2016/0029638 A1
(43) Pub. Date: Feb. 4, 2016

(54) SPOT-ON PESTICIDE COMPOSITION COMPRISING A NEONICOTINOID AND A PYRETHROID

(71) Applicant: SERGEANT'S PET CARE PRODUCTS, INC., Omaha, NE (US)

(72) Inventor: Larry Nouvel, Plano, TX (US)

(73) Assignee: SERGEANT'S PET CARE PRODUCTS, INC., Omaha, NE (US)

(21) Appl. No.: 14/776,429

(22) PCT Filed: Mar. 14, 2014
(86) PCT No.: PCT/US14/28515

§ 371 Date: Sep. 14, 2015

Related U.S. Application Data
(60) Provisional application No. 61/781,906, filed on Mar. 14, 2013.
(60) Provisional application No. 61/781,925, filed on Mar. 14, 2013.
(60) Provisional application No. 61/781,912, filed on Mar. 14, 2013.
(60) Provisional application No. 61/781,920, filed on Mar. 14, 2013.

(51) Int. Cl. A01N 51/00; A01N 31/14; A01N 37/36; A01N 53/00

(52) U.S. Cl. CPC A01N 51/00; A01N 53/00; A01N 31/14; A01N 37/36

(57) ABSTRACT

A spot-on pesticide composition for animals, specifically mammals, including dogs and cats, which composition comprises a combination of active components, the active components being a combination of a neonicotinoid and a pyrethroid, and optionally comprising an insect growth regulator, in doses and proportions which are parasiticidally effective against a variety of insects and pests, and in a formulation which is convenient for local application to the animal's skin, preferably localized over a small surface area.

### RELATED APPLICATIONS

This application relates to and claims the priority of U.S. Provisional Patent Application Ser. No. 61/781,906, which was filed Mar. 14, 2013, U.S. Provisional Patent Application Ser. No. 61/781,912, which was filed Mar. 14, 2013, U.S. Provisional Patent Application Ser. No. 61/781,920, which was filed Mar. 14, 2013, and U.S. Provisional Patent Application Ser. No. 61/781,925, which was filed Mar. 14, 2013, each of which is hereby incorporated by reference in its entirety.

### FIELD OF THE INVENTION

The present invention relates to a pesticide composition comprising a neonicotinoid and a pyrethroid, which combination is useful in the treatment or prevention of insect, parasite, or tick infestations in animals, specifically mammals, including dogs and cats. Specifically the present invention relates to a spot-on or pour-on pesticide composition comprising a neonicotinoid and a pyrethroid, and further may include an insect growth regulator. The present invention further relates to a method of killing insect and pest pupae and adults on an animal by locally administering a cutaneous application of the pesticide composition between the shoulders of the animal.

### BACKGROUND OF THE INVENTION

Traditional products for the treatment or prevention of insect or parasite infestation of animals include shampoo treatments, insecticidal collars, orally ingested treatments, compositions designed to treat an animal's environment, spot-on treatments, and the like. Different treatment forms offer unique benefits and drawbacks; however, the majority offer substantial disadvantages. For instance, shampoo treatments require that the treatment be applied over the entire surface of the animal and subsequently rinsed off, which is typically unpleasant for both the animal and the owner and only provides a short-term, transient treatment. Insecticidal collars require the animal to physically wear the collar for a period of time often lasting several months, which is uncomfortable and burdensome to the animal. Additional, treatments administered orally tend to increase the possibility of side effect and are more difficult to administer to the animal. Alternatively, treatment of the animal's surroundings and habitat is often undesirable due to the fact that the treatment may cause discoloration of furniture, carpet, bedding, etc., and may also produce unpleasant odors. Thus, it is desirable to have a spot-on treatment that can be applied to the animal in smaller portions, while maintaining treatment efficacy across the entire body surface of the animal.

Spot-on compositions that have been previously developed incorporate a multitude of pesticide agents. Common agents include arylpyrazole derivatives, insect growth regulators, pyrethroids, nodulisporic acid derivatives, neonicotinoids, formamides, avermectins, and the like. All of the compounds listed herein have different mechanisms of action, and accordingly treat and prevent infestation in different manners. Consequently, the various compounds also have a variety of different adverse effects associated with treatment. The various agents may be combined in a variety of concentrations. Generally, higher concentrations of the active components result in higher pest kill rates, and more successful treatments; however, the use of higher concentrations of the active components are more expensive to make and result in a greater likelihood that the animal will suffer adverse effects from treatment. Adverse effects of treatments include skin discoloration, local hair loss, itching, paresthesia, redness, excessive salivation, and in certain cases, neurotoxicity.

The spot-on treatments known within the art generally have a prolonged period of action before the active ingredient(s) effectively eliminates the target pest. For instance, insect growth regulators (i.e. juvenile hormone mimetics) exterminate target pests by effectively inhibiting the development of immature pests, so that they are not able to reproduce. Even though the insect growth regulators are effective in ultimately controlling the pest infestation, additional time is required to kill all pests, which leads to additional time in which the animal host, as well as all other animals and humans, must suffer the effects of the infestation. Even agents that are known to be quick-acting, such as the phenylpyrazole known as fipronil, which causes hyperexcitation of the pest leading to its death, have a prolonged onset of action. Generally, it may take multiple hours for quick-acting agents to provide symptomatic relief to the host animal.

Therefore, given the limitations of the prior art, it would be desirable to have a spot-on pesticide treatment that utilizes low concentrations of known chemicals so as to minimize the risk of adverse effects, has a high pest kill rate, and has an improved kill rate, preferably within the first hour of treatment.

### SUMMARY OF THE INVENTION

The present invention relates to novel pesticide compositions for treating and preventing insect or tick infestation, as well as a method of killing pests comprising applying the compositions to a host animal, specifically a mammal. The pesticide compositions of the current invention comprise low concentrations of the active components. The pesticide compositions generally comprise a neonicotinoid selected from the group consisting of imidacloprid, acetamiprid, nithiazine, thiamethoxam, dinotefuran, nitenpyram, thiacloprid, clothianadin, and combinations thereof, and a pyrethroid selected from the group consisting of permethrin, cypermethrin, cyphenothrin, etofenprox, fenvalerate, cyfluthrin, and combinations thereof, in which the active agents are each present in the composition in concentrations generally less than 20% by weight of the total weight of the total spot-on composition. Such low concentrations minimize the risk of adverse effects. It has further been discovered that these novel combinations of active components have a higher and faster kill rate of pests (e.g. fleas and ticks) than treatment with a neonicotinoid alone or without a pyrethroid. The compositions of the present invention further comprise an organic solvent and may optionally include an antioxidant.

Generally, the present invention is directed to a pesticide composition comprising between about 1% and about 20% (w/w) of a neonicotinoid selected from the group consisting of imidacloprid, acetamiprid, nithiazine, thiamethoxam, dinotefuran, nitenpyram, thiacloprid, clothianadin, and combinations thereof, and between about 1% and about 20% (w/w) of a pyrethroid selected from the group consisting of permethrin, cypermethrin, cyphenothrin, etofenprox, fenvalerate, cyfluthrin, and combinations thereof.

Further, the present invention is directed to a spot-on pesticide compositions comprising between about 1% and about 20% (w/w) of a neonicotinoid selected from the group consisting of imidacloprid, acetamiprid, nithiazine, thiamethoxam, dinotefuran, nitenpyram, thiacloprid, clothianadin, and combinations thereof, between about 1% and about 20% (w/w) of a pyrethroid selected from the group consisting of permethrin, cypermethrin, cyphenothrin, etofenprox, fenvalerate, cyfluthrin, and combinations thereof, and between about 55% and about 80% (w/w) of an organic solvent. Optionally, the spot-on composition may further comprise an insect growth regulator and/or an antioxidant.

In addition, the present invention further provides a method of eliminating and preventing pest infestations on an animal, specifically a dog or a cat, the method comprising administering a localized cutaneous application of a spot-on composition comprising between about 1% and about 20% (w/w) of a neonicotinoid selected from the group consisting of imidacloprid, acetamiprid, nithiazine, thiamethoxam, dinotefuran, nitenpyram, thiacloprid, clothianadin, and combinations thereof, between about 1% and about 20% (w/w) of a pyrethroid selected from the group consisting of permethrin, cypermethrin, cyphenothrin, etofenprox, fenvalerate, cyfluthrin, and combinations thereof, between the shoulders of the animal in a volume sufficient to deliver a dose of the active components ranging from about 0.5 mg/kg to about 10 mg/kg of animal body weight.

Unless otherwise defined, all technical and scientific terms used herein have the same meaning as is commonly understood by one of skill in the art to which this invention belongs at the time of filing. If specifically defined, then the definition provided herein takes precedent over any dictionary or extrinsic definition. Further, unless otherwise required by context, singular terms shall include pluralities, and plural terms shall include the singular. Herein, the use of “or” means “and/or” unless stated otherwise. All patents and publications referred to herein are incorporated by reference.

### DETAILED DESCRIPTION OF THE INVENTION

The compositions provided herein are spot-on pesticide compositions that utilize combinations of certain active compounds to treat insect, parasite, or tick infestation of animals, specifically mammals (preferably dogs and cats), and also prevent future infestations by prolonged treatment efficacy that can last up to three months. As such, the compositions exterminate existing pests, and prevent those pests that survive from developing and reproducing. The compositions halt the growth cycle and prevent pests from laying additional eggs. The compositions of the current invention are useful in the treatment of many pests, especially fleas and ticks found on domesticated animals. The compositions include low concentrations of a neonicotinoid and a pyrethroid, and may further comprise an insect growth-regulating compound. In addition, the present invention is based in part on the finding that treatment of a host animal with compositions comprising a combination of a neonicotinoid and a pyrethroid results in dramatically higher kill rates within the first twenty-four hours of treatment than does treatment with a neonicotinoid, alone or combined with an insect growth regulator, without the addition of a pyrethroid.

Generally, the spot-on pesticide composition comprises from about 1% to about 20% by weight of a neonicotinoid selected from the group consisting of imidacloprid, acetamiprid, nithiazine, thiamethoxam, dinotefuran, nitenpyram, thiacloprid, clothianadin, and combinations thereof, and from about 1% to about 20% by weight of a pyrethroid selected from the group consisting of permethrin, cypermethrin, cyphenothrin, etofenprox, fenvalerate, cyfluthrin, and combinations thereof. All percents provided herein are percent by weight based on the total weight of the composition unless otherwise indicated.

The spot-on pesticide compositions comprise a combination of active pesticides, wherein the active pesticides comprise a neonicotinoid and a pyrethroid, and may optionally include other active pesticides known in the art. Alternatively, the active pesticides may consist only of a neonicotinoid and a pyrethroid as the active pesticides.

The neonicotinoid is selected from the group consisting of imidacloprid, acetamiprid, nithiazine, thiamethoxam, dinotefuran, nitenpyram, thiacloprid, and clothianadin. Neonicotinoids achieve their efficacy by binding on insect nerve receptors, causing excitation of the nerve and muscle contraction. This particular class of pesticides is known to bind to the postsynaptic nicotinic acetylcholine receptors (nAChR) and stimulate the nerves to fire off an impulse for a sustained muscular contraction, which causes a spastic paralysis. Further nerve conduction is the prevented and he prolonged contraction damages muscles and nerves, causing disintegration and leading to the death of the parasite.

The amount of neonicotinoid present in the composition may be equal to from about 1% to about 20% by weight. In some embodiments, the neonicotinoid comprises about 20%, 19%, 18%, 17%, 16%, 15%, 14%, 13%, 12%, 11%, 10%, 9%, 8%, 7%, 6%, 5%, 4%, 3%, 2%, or 1% (w/w) of the spot-on composition. For example, the amount of neonicotinoid present in the spot-on composition may range from between about 1% to about 20% (w/w) of the total composition, and preferably ranges from between about 5% and about 15% (w/w). Most preferably, the amount of neonicotinoid present in the spot-on composition may range from between about 7% and about 12% (w/w) of the total composition. In an exemplary embodiment, the amount of neonicotinoid present in the composition is about 9.58% (w/w) of the total composition.

In a preferred embodiment of the present invention, the neonicotinoid is imidacloprid. Imidacloprid is also known as N-[1-[(6-Chloro-3-pyridyl)methyl]-4,5-dihydroimidazol-2-yl]nitramide and is sold as a pesticide commercially under the name Advantage® (Bayer). The chemical structure for imidacloprid is shown below.

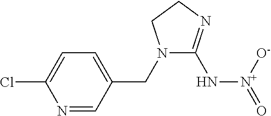 [SMILES: O=[N+]([O-])NC1=NCCN1Cc1ccc(Cl)nc1]

It is understood that analogs and associated derivatives of imidacloprid (including enantiomers, diastereomers, racemates, or pharmaceutically acceptable salts thereof) are also within the scope of the present invention.

The pyrethroid is selected from the group consisting of permethrin, cypermethrin, cyphenothrin, etofenprox, fenvalerate, and cyfluthrin. Generally, pyrethroids are a class of synthetic insecticides that are related to the naturally-occurring pyrethrins. Pyrethroids tend to be more effective than the natural pyrethrins, and less toxic to mammals. Pyrethroids are axonic poisons that work by keeping the sodium channels open in the neuronal membranes. The sodium channel consists of a membrane protein with a hydrophilic interior which permits sodium ions to enter and exit the membrane. When the sodium channels are kept open, the influx of sodium ions results in hyperexcitation, and the pest becomes paralyzed.

The amount of pyrethroid present in the spot-on pesticide composition is between about 1% and about 20% (w/w) of the total weight of the composition. In some embodiments, the pyrethroid comprises about 20%, 19%, 18%, 17%, 16%, 15%, 14%, 13%, 12%, 11%, 10%, 9%, 8%, 7%, 6%, 5%, 4%, 3%, 2%, or 1% (w/w) of the spot-on composition. For example, the amount of pyrethroid present in the spot-on composition may range from between about 1% to about 20% (w/w) of the total composition, and preferably ranges from about 2% to about 18% (w/w). In another embodiment, the amount of pyrethroid present in the spot-on composition may range from about 5% to about 16% (w/w) of the total composition weight. In another embodiment, the amount of pyrethroid present in the spot-on composition may range from about 10% to about 20% (w/w) of the total composition weight. In a further embodiment, the amount of pyrethroid present in the spot-on composition may range from about 10% to about 15% (w/w) of the total composition weight.

In an embodiment of the present invention, the pyrethroid is cyphenothrin. Cyphenothrin is also known as (RS)-α-cyano-3-phenoxybenzyl (1RS,3RS;1RS,3SR)-2,2-dimethyl-3-(2-methylprop-1-enyl)cyclopropanecarboxylate, d-trans-cyphenothrin, d-cyphenothrin, Gokilaht™, (RS)-α-cyano-3-phenoxybenzyl-(1RS)-cis-trans-2,2-dimethyl-3-(2-methylprop-1-enyl)cyclopropanecarboxylate, (±)-α-cyano-3-phenoxybenzyl (±)-cis-trans-chrysanthemate, and cyano(3-phenoxyphenyl)methyl 2,2-dimethyl-3-(2-methyl-1-propenyl)cyclopropanecarboxylate. Certain commercially available Gokilaht™ products on the market incorporate both cyphenothrin and pyriproxyfen. It should be noted that the cyphenothrin product of the current invention may only incorporate the active compound pyriproxyfen in those formulations not also containing S-methoprene due to the discovery that the incorporation of both S-methoprene and pyriproxyfen in a composition decreases efficacy and increases the likelihood of adverse effects. The chemical structure for cyphenothrin is shown below.

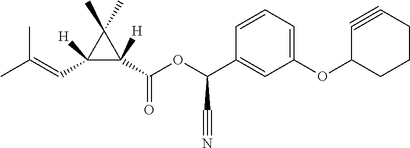

In one exemplary embodiment, the amount of cyphenothrin present in the spot-on composition effective for the treatment of pest infestations in dogs is about 5.4% (w/w) of the total composition.

In another embodiment of the present invention, the pyrethroid is etofenprox. Etofenprox is also known as ethofenprox, ethophenprox, 1-ethoxy-4-[2-methyl-1-[[3-(phenoxy)phenyl]methoxylpropan-2-yl]benzene 2-(4-Ethoxyphenyl)-2-methylpropyl 3-phenoxybenzyl ether, 3-Phenoxybenzyl 2-(4-ethoxyphenyl)-2-methylpropyl ether, C076840, 2-(4-ethoxyphenyl)-2-methylpropyl-3-phenoxybenzyl ether, 1-((2-(4-Ethoxyphenyl)-2-methylpropoxy)methyl)-3-phenoxybenzene, alpha-((p-Ethoxy-beta,beta-dimethylphenethyl)oxy)-m-phenoxytoluene. The CAS Registration number for etofenprox is 80844-07-1. Etofenprox is known to be an effective pyrethroid for the elimination of pests in cats. The chemical structure for etofenprox is shown below.

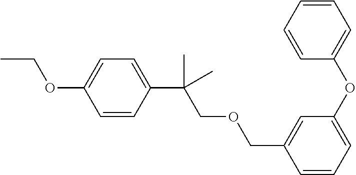 [SMILES: CCOc1ccc(C(C)(C)COCc2cccc(Oc3ccccc3)c2)cc1]

In an exemplary embodiment, the amount of etofenprox present in the spot-on composition effective for the treatment of pest infestations in cats is about 15% (w/w) of the total composition.

The spot-on pesticide composition of the present invention may additionally include an insect growth regulator (IGR). IGRs are not effective in killing pre-existing pests; they prevent reproduction and further infestation. An IGR is generally a compound that is capable of disrupting the growth and development of pest species, so that the pest cannot mature and reproduce. There are two common classes of IGRs, namely juvenile hormone mimics (or juvenoids) and chitin synthesis inhibitors (CSIs).

Juvenoids, such as hydroprene, methoprene, kinoprene, triprene, fenoxycarb, and pyriproxyfen, bind to juvenile hormone binding cite receptors and mimic the action of the juvenile hormones, thereby inhibiting embryogenesis, metamorphosis and adult formation. CSIs, such as novaluron, prevent the formation of chitin, a carbohydrate needed to form the insect's exoskeleton. With these inhibitors, an insect grows normally until it molts. The inhibitors prevent the new exoskeleton from forming properly, causing the insect to die. Death may be quick, or may take up to several days or months depending on the insect. CSIs can also kill eggs by disrupting normal embryonic development.

The amount of IGR present in the current invention may comprise between about 0.1% and about 20% (w/w) of the total weight of the spot-on composition. In some embodiments, the IGR comprises about 19%, 18%, 17%, 16%, 15%, 14%, 13%, 12%, 11%, 10%, 9%, 8%, 7%, 6%, 5%, 4%, 3%, 2%, 1%, or 0.1% (w/w) of the spot-on composition. For example, the amount of IGR present in the spot-on composition may range from between 0.1% to about 20% (w/w) of the total composition weight, and preferably the IGR ranges from between about 5% to about 15% (w/w) of the total composition.

IGRs useful in the present invention may include, but are not limited to both juvenile hormone mimics and chitin synthesis inhibitors. Suitable non-limiting examples of insect growth regulators that may be used in the present invention include bistrifluron, buprofezin, chlorfluazuron, cyromazine, diflubenzuron, flucycloxuron, flufenoxuron, hexaflumuron, lufenuron, novaluron, noviflumuron, penfluron, teflubenzuron, triflumuron, epofenonane, fenoxycarb, hydroprene, kinoprene, methoprene, pyriproxyfen, triprene, and combinations thereof. In one embodiment, the insect growth regulator is a juvenoid. Preferably, the juvenoid is S-methoprene or pyriproxyfen.

Generally, methoprene is a racemic mixture of the R- and S-enantiomers of the compound, however, only the S-enantiomer is active as a juvenile hormone analog. A juvenile hormone analog exerts a therapeutic effect by mimicking the natural juvenile hormones found within pests. Juvenile hormone must be absent for a pupa to molt to an adult, so methoprene treated larvae are unable to successfully develop from pupa to an adult pest. This action breaks the natural life cycle of the pest, preventing it from maturing and reproducing. S-methoprene is also known as isopropyl (2E, 4E, 7S)-11-methoxy-3,7,11-trimethyl-2,4-dodecadienoate and its chemical structure is shown below.

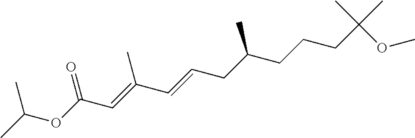 [SMILES: COC(C)(C)CCC[C@H](C)C/C=C/C(C)=C/C(=O)OC(C)C]

It is understood that analogs and associated derivatives of S-methoprene (including enantiomers, diastereomers, racemates, or pharmaceutically acceptable salts thereof) are also within the scope of the present invention.

S-methoprene is available in a variety of commercial products and is useful in controlling long-term pest infestation, while other active components are primarily effective in the immediate, short-term elimination of pests. The pest kill time for treatment with S-methoprene will vary depending on the typical duration of life for the species being treated. Unlike some other compounds, S-methoprene is generally considered non-toxic to humans, which has led to its use in the treatment of well cisterns and a number of food items, including meat, milk, mushrooms, peanuts, rice, and cereals. In an exemplary embodiment, the amount of S-methoprene present in the spot-on composition effective for the treatment of pest infestations in animals is 12.36% (w/w).

In an alternative embodiment (i.e. those embodiments of the present invention that do not contain S-methoprene), the IGR may be the juvenile hormone analog pyriproxyfen, also known as 4-phenoxyphenyl 2-(2-pyridyloxy)propyl ether and Nylar™. The chemical structure for pyriproxyfen is shown below.

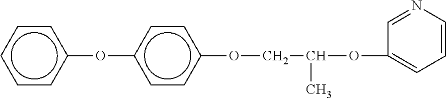

It is understood that analogs and associated derivatives of pyriproxyfen (including enantiomers, diastereomers, racemates, or pharmaceutically acceptable salts thereof) are also within the scope of the present invention.

In an alternative embodiment, the IGR is a chitin synthesis inhibitor, preferably novaluron. Novaluron is also known as (RS)-1-[3-chloro-4-(1,1,2-trifluoro-2-trifluoromethoxyethoxy)phenyl]-1-3-(2,6-difluorobenzoyl)urea. The chemical structure for novaluron is shown below.

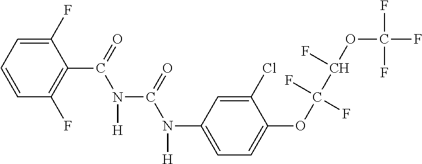 [SMILES: O=C(NC(=O)c1c(F)cccc1F)Nc1ccc(OC(F)(F)C(F)OC(F)(F)F)c(Cl)c1]

It is understood that analogs and associated derivatives of novaluron (including enantiomers, diastereomers, racemates, or pharmaceutically acceptable salts thereof) are also within the scope of the present invention.

The spot-on compositions of the present invention, which are non-aqueous, also comprise an organic solvent. Generally, the organic solvent is defined as a carbon-containing chemical that is capable of dissolving a solid, liquid, or a gas. Although one skilled in the art will appreciate that a wide variety of solvents may be incorporated into the current invention, the solvents should generally have a dielectric constant ranging from about 1 to 40, a low boiling point (less than 100° C.), have a density less than the density of water (less than 1.0 at 20° C.), and generally be soluble with water. In addition, the organic solvent should cause minimal cutaneous irritation when applied to the skin of an animal, including a dog or cat. Suitable examples of organic solvents include, but are not limited to, acetyltributyl citrate, fatty acid esters such as dimethyl ester, diisobutyl adipate, acetone, acetonitrile, benzyl alcohol, butyl diglycol, dimethylacetamide, dimethylformamide, dimethyl sulfoxide (DMSO), dipropylene glycol n-butyl ether, ethanol, isopropanol, methanol, ethylene glycol monoethyl ether, ethylene glycol monomethyl ether, diethylene glycol monoethyl ether, monomethylacetamide, dipropylene glycol monomethyl ether, liquid polyoxyethylene glycols, propylene glycol, 2-pyrrolidones such as N-methylpyrrolidone, N-octylpyrrolidone, and N-decylpyrrolidone, diethylene glycol monoethyl ether, ethylene glycol, diethyl phthalate, ethoxydiglycol, ethylhexyl acetate, or combinations thereof. In a preferred embodiment, the organic solvent comprises diethylene glycol monoethyl ether.

In addition, the organic solvent generally comprises between about 40% to about 90% (w/w) of the spot-on composition. In some embodiments, the organic solvent comprises about 90%, 85%, 80%, 75%, 70%, 65%, 60%, 55%, 50%, 45%, or 40% (w/w) of the total composition. For example, the amount of organic solvent present in the spot-on composition preferably ranges from between about 40% and about 90% (w/w) of the composition, and preferably ranges from between about 50% and about 85% (w/w). In another embodiment, the amount of organic solvent in the spot-on composition ranges from between about 50% to about 60% (w/w) of the total composition. In an additional embodiment, the amount of organic solvent in the spot-on composition ranges from between about 70% to 80% (w/w) of the total composition. In still another embodiment, the amount of organic solvent in the spot-on composition ranges from between about 60% to 70% (w/w).

The spot-on composition may further comprise an antioxidant. An antioxidant is generally defined as a compound capable of slowing or preventing the oxidation of other molecules. Oxidation is a chemical reaction that transfers electrons from the original substance to an oxidizing agent. Oxidation reactions can produce free radicals, which start chain reactions that damage cells. Antioxidants terminate these chain reactions by removing free radical intermediates, and inhibit other oxidation reactions by being oxidized themselves. Within the spot-on composition, the antioxidant acts as a stabilizer, preventing the various components from degrading by oxidation processes. In addition, many of the commercially-available compositions that incorporate a pyrethroid, including cyphenothrin have reported that the animals suffer from adverse effects including paraesthesia (a skin sensation that generally comprises feelings of prickling, itching, and tingling). However, it has been shown that inclusion of an antioxidant into the spot-on composition helps to prevent the undesirable adverse effects associated with treatment regimens that include cyphenothrin. It should be noted that the spot-on compositions of the present invention do not include crystallization inhibitors.

Antioxidants incorporated into the current invention should generally be miscible with the organic solvents described herein. The antioxidant also should not cause irritation to the skin of an animal, specifically a dog or cat, when applied to the animal's skin. In addition, the antioxidant may be natural or synthetic. Suitable antioxidants include, but are not limited to, ascorbic acid and its salts, ascorbyl palmitate, ascorbyl stearate, anoxomer, N-acetylcysteine, benzyl isothiocyanate, m-aminobenzoic acid, o-aminobenzoic acid, p-aminobenzoic acid (PABA), butylated hydroxyanisole (BHA), butylated hydroxytoluene (BHT), caffeic acid, canthaxantin, alpha-carotene, beta-carotene, beta-carotene, beta-apo-carotenoic acid, carnosol, carvacrol, catechins, cetyl gallate, chlorogenic acid, citric acid and its salts, clove extract, coffee bean extract, p-coumaric acid, 3,4-dihydroxybenzoic acid, N,N′-diphenyl-p-phenylenediamine (DPPD), dilauryl thiodipropionate, distearyl thiodipropionate, 2,6-di-tert-butylphenol, dodecyl gallate, edetic acid, ellagic acid, erythorbic acid, sodium erythorbate, esculetin, esculin, 6-ethoxy-1,2-dihydro -2,2,4-trimethylquino line, ethyl gallate, ethyl maltol, ethylenediaminetetraacetic acid (EDTA), eucalyptus extract, eugenol, ferulic acid, flavonoids (e.g., catechin, epicatechin, epicatechin gallate, epigallocatechin (EGC), epigallocatechin gallate (EGCG), polyphenol epigallocatechin-3-gallate), flavones (e.g., apigenin, chrysin, luteolin), flavonols (e.g., datiscetin, myricetin, daemfero), flavanones, fraxetin, fumaric acid, gallic acid, gentian extract, gluconic acid, glycine, gum guaiacum, hesperetin, alpha-hydroxybenzyl phosphinic acid, hydroxycinammic acid, hydroxyglutaric acid, hydroquinone, N-hydroxysuccinic acid, hydroxytryrosol, hydroxyurea, rice bran extract, lactic acid and its salts, lecithin, lecithin citrate; R-alpha-lipoic acid, lutein, lycopene, malic acid, maltol, 5-methoxy tryptamine, methyl gallate, monoglyceride citrate; monoisopropyl citrate; morin, beta-naphthoflavone, nordihydroguaiaretic acid (NDGA), octyl gallate, oxalic acid, palmityl citrate, phenothiazine, phosphatidylcholine, phosphoric acid, phosphates, phytic acid, phytylubichromel, pimento extract, propyl gallate, polyphosphates, quercetin, trans-resveratrol, rosemary extract, rosmarinic acid, sage extract, sesamol, silymarin, sinapic acid, succinic acid, stearyl citrate, syringic acid, tartaric acid, thymol, tocopherols (i.e., alpha-, beta-, gamma- and delta-tocopherol), tocotrienols (i.e., alpha-, beta-, gamma- and delta-tocotrienols), tyrosol, vanillic acid, 2,6-di-tert-butyl-4-hydroxymethylphenol (i.e., Ionox 100), 2,4-(tris-3′,5′-bi-tert-butyl-4′-hydroxybenzyl)-mesitylene (i.e., Ionox 330), 2,4,5-trihydroxybutyrophenone, ubiquinone, tertiary butyl hydroquinone (TBHQ), thiodipropionic acid, trihydroxy butyrophenone, tryptamine, tyramine, uric acid, vitamin K and derivatives, vitamin Q10, wheat germ oil, zeaxanthin, or combinations thereof. One skilled in the art will appreciate that the antioxidants incorporated into the composition (including those listed herein) encompass all potential salt and ester forms of the antioxidants in addition to the pure forms of the compound. Preferably, the antioxidant comprises a vitamin E compound and may be selected from the group consisting of tocopherol acetate, tocopherol linoleate, tocopherol nicotinate, tocopherol succinate, ascorbyl tocopherol phosphate, dioleyl tocopherol methylsilanol, tocophersolan, tocopherol linoleate/oleate, and combinations thereof. In an exemplary embodiment, the antioxidant comprises tocopherol nicotinate [CAS No. 43119-47-7].

In addition, the antioxidant typically comprises less than about 10% (w/w) of the total spot-on composition. In some embodiments, the antioxidant comprises about 10%, 9%, 8%, 7%, 6%, 5%, 4%, 3%, 2%, 1%, or 0.1% (w/w) of the total composition. For example, the amount of antioxidant present in the spot-on composition may range from between 2% to about 10% (w/w) of the total composition, and preferably the antioxidant ranges from between about 3% to about 6% (w/w) of the total composition. In a further embodiment, the amount of antioxidant present in the spot-on composition ranges from between about 4% to about 6% (w/w) of the total composition. In an exemplary embodiment, the amount of antioxidant present in the composition is about 5.1% (w/w).

The spot-on composition may further include inactive excipients that are added to the composition as a result of their incorporation into the individual active components. For instance, the neonicotinoid component of the composition may be provided in a 95% solution, meaning that 95% of the neonicotinoid component volume is active pesticide and the remaining 5% constitutes inactive excipients that are consequently introduced into the composition, as such the pesticide may not be 100% pure concentrate and may be purchased with other constituents. One skilled in the art will recognize that the inactive excipients include, but are not limited to binders, fillers, non-effervescent disintegrants, effervescent disintegrants, preservatives, diluents, lubricants, pH modifiers, stabilizers, and the like. It should, however, be understood that the inactive excipients are typically incorporated as a portion of the active ingredient components and comprise a small percentage (generally less than 1%) of the total spot-on composition volume, generally not affecting the physical characteristics of the spot-on composition.

It should be understood that the active components of the spot-on composition may be provided in the form of pure concentrate (100% concentration) or a diluted composition with additional excipients in the dosage form (i.e. the amount of active ingredient in the composition is less than or equal to 99.99%, and the remainder consists of inactive excipients). One of skill in the art will appreciate that the volume of active component added to the spot-on composition will need to be adjusted to account for the dilution and to ensure the end spot-on composition comprises the appropriate final concentration of each of the active components. One of skill in the art will also appreciate that the various components of the spot-on composition may be provided in a variety of dosage forms including, but not limited to powder, briquettes, liquid solution or suspension, pellets, emulsion, aerosol, cream, gel, ointment, and the like.

Additionally, the spot-on pesticide composition of the current invention can be produced by contacting the various active components of the spot-on composition with one another to produce a spot-on formulation suitable for application to an animal's skin. It should be understood that the current invention encompasses a variety of physical formulations; however, the spot-on compositions of the current invention are generally directed to liquid solutions and suspensions. The formulations of the present invention may be prepared by standard techniques known in the art. For instance, in one embodiment where the desired spot-on formulation is a liquid solution, the composition is produced by bringing the neonicotinoid and pyrethroid compounds into contact with a solvent system and then gently heating and stirring the components until dissolved. In a preferred embodiment, the spot-on composition comprising fipronil, a pyrethroid, and a solvent system may further be contacted with an antioxidant, and the combination is then stirred to create a spot-on composition. A person having ordinary skill in the art will appreciate that the various components of the spot-on composition may be contacted and mixed with one another in any order desired, so long as solution is adequately stirred and mixed.

The physical characteristics of the spot-on composition may vary depending upon the physical characteristics desired. However, the spot-on composition should be capable of application to the skin of an animal and provide adequate stasis to allow the active components of the spot-on composition to be absorbed by the host animal. Preferably, the spot-on compositions of the present invention have low viscosity. Viscosity is the measurement of flow resistance due to internal friction within the fluid, and is measured in centistokes (cSt). A lower cSt measurement means the fluid will flow with less resistance, because of minimal molecular friction within the fluid. The lower the viscosity the faster the fluid will flow. High viscosity substances are liquids that are thick and gelatinous in nature with slow flow. Low viscosity substances exhibit a fast flow with an example being water at room temperature (water at 20° C. has a viscosity of about 1 cSt; 1 cSt=1 mm²/second). The spot-on compositions of the present invention typically have a viscosity ranging from about 0.01 mm²/second to about 100 mm²/second. In a more preferred embodiment, the spot-on composition has a viscosity ranging from about 1 mm²/second to about 30 mm²/second. In a further preferred embodiment, the spot-on composition has a viscosity ranging from about 4 mm²/second to about 20 mm²/second.

A basic spot-on composition of the present invention will preferably include between about 1% and about 20% (w/w) of a neonicotinoid selected from the group consisting of imidacloprid, acetamiprid, nithiazine, thiamethoxam, dinotefuran, nitenpyram, thiacloprid and clothianadin, between about 1% and about 20% (w/w) of a pyrethroid selected from the group consisting of permethrin, cypermethrin, cyphenothrin, etofenprox, fenvalerate, and cyfluthrin, between about 40% and about 90% (w/w) of an organic solvent, and between about 1% and about 10% (w/w) of an antioxidant. If the spot-on composition additionally includes an IGR, the IGR will preferably be present at between about 0.1% and about 20% (w/w) of the composition, preferably between about 2% to about 15% (w/w) of the total composition.

In a preferred embodiment, the present invention provides a spot-on composition comprising between about 5% and about 15% (w/w) imidacloprid, between about 2% and about 10% (w/w) cyphenothrin, between about 70% and about 80% (w/w) organic solvent, and between about 1% and about 10% (w/w) antioxidant. This spot-on composition can be used to treat any mammal, but it is very desirable for treating dogs.

Another preferred embodiment of the present invention comprises a spot-on composition comprising between about 5% and about 15% (w/w) imidacloprid, between about 2% and about 10% (w/w) cyphenothrin, between about 0.1% and about 20% (w/w) S-methoprene, between about 60% and about 70% (w/w) organic solvent, and between about 1% and about 10% (w/w) antioxidant. This spot-on composition can be used to treat any mammal, but it is very desirable for treating dogs.

In yet another preferred embodiment the present invention provides a spot-on composition comprising between about 5% and about 15% (w/w) imidacloprid, between about 10% and about 20% (w/w) etofenprox, between about 0.1% and about 20% (w/w) S-methoprene, between about 50% and about 60% (w/w) organic solvent, and between about 1% and about 10% (w/w) antioxidant. This spot-on composition can be used to treat any mammal, but it is very desirable for treating cats.

In a further preferred embodiment the present invention provides a spot-on composition comprising 5% and about 15% (w/w) imidacloprid, between about 10% and about 20% (w/w) etofenprox, between about 70% and about 80% (w/w) organic solvent, and between about 1% and about 10% (w/w) antioxidant. This spot-on composition can be used to treat any mammal, but it is very desirable for treating cats.

In addition, the current invention further embodies a method of killing pest pupae and adults on an animal comprising administering a localized cutaneous application between the shoulders of the animal, a spot-on composition comprising between about 1% to 20% (w/w) of a neonicotinoid selected from the group consisting of imidacloprid, acetamiprid, nithiazine, thiamethoxam, dinotefuran, nitenpyram, thiacloprid and clothianadin, and between about 1% to 20% (w/w) of a pyrethroid selected from the group consisting of permethrin, cypermethrin, cyphenothrin, etofenprox, fenvalerate, and cyfluthrin. The method of the using the composition of the present invention preferably involves the localized administration of the basic spot-on composition to an animal, which composition preferably comprises between 5% and about 15% (w/w) imidacloprid and between about 2% to about 10% (w/w) cyphenothrin, and may additionally include an IGR preferably at a concentration range from between about 0.1% to about 20% (w/w) of the total composition. The method of the using the composition of the present invention may also preferably involve the localized administration of the basic spot-on composition to an animal, which composition preferably comprises between 5% and about 15% (w/w) imidacloprid and between about 10% to about 20% (w/w) etofenprox, and may additionally include an IGR preferably at a concentration range from between about 0.1% to about 20% (w/w) of the total composition.

The compositions and method according to this invention are intended for application to animals, in particular dogs and cats, and are generally applied by deposition onto the skin (“spot-on” or “pour-on” application). Treatment typically comprises a localized application over a surface area of less than 10 cm², especially of between 5 and 10 cm². Generally, the spot-on composition should be applied to an area where the animal cannot lick the application area, as licking of the application area may lead to transient adverse effects, such as excessive salivation. In particular, application is preferred at two points and preferably localized between the animal's shoulders. After the spot-on composition has been applied, the composition diffuses, in particular over the animal's entire body, and then dries without crystallizing or modifying the appearance (in particular absence of any whitish deposit or dusty appearance) or the feel of the animal's fur. Further, the method of the current invention is directed to application of the spot-on composition to the skin of the animal every four weeks to ensure continuous treatment and prevention of pest infestation. Typically, the active constituents are applied to the host animal together in a single formulation.

In a preferred embodiment of the invention, the method of killing insect and pest pupae and adults on an animal, comprises administering a localized cutaneous application between the shoulders of an animal, a spot-on composition comprising between about 5% and about 15% (w/w) imidacloprid, between about 2% and about 10% (w/w) cyphenothrin, between about 70% and about 80% (w/w) organic solvent, and between about 1% and about 10% (w/w) antioxidant. This method can be used to treat any animal, but it is very desirable for treating dogs.

Another preferred embodiment of the present invention comprises a method of killing insect and pest pupae and adults on a dog or cat, comprising administering a localized cutaneous application between the shoulders of an animal, a spot-on composition comprising 5% and about 15% (w/w) imidacloprid, between about 2% and about 10% (w/w) cyphenothrin, between about 0.1% and about 20% (w/w) S-methoprene, between about 60% and about 70% (w/w) organic solvent, and between about 1% and about 10% (w/w) antioxidant. This method can be used to treat any animal, but it is very desirable for treating dogs.

In yet another preferred embodiment the present invention provides a method of killing insect and pest pupae and adults on an animal, comprising administering a localized cutaneous application between the shoulders of an animal, of a spot-on composition comprising 5% and about 15% (w/w) imidacloprid, between about 10% and about 20% (w/w) etofenprox, and between about 70% and about 80% (w/w) organic solvent, and between about 1% and about 10% (w/w) antioxidant. This method can be used to treat any animal, but it is very desirable for treating cats.

In yet another preferred embodiment the present invention provides a method of killing insect and pest pupae and adults on an animal, comprising administering a localized cutaneous application between the shoulders of an animal, a spot-on composition comprising 5% and about 15% (w/w) imidacloprid, between about 10% and about 20% (w/w) etofenprox, between about 0.1% and about 20% (w/w) S-methoprene, between about 50% and about 60% (w/w) organic solvent, and between about 1% and about 10% (w/w) antioxidant. This method can be used to treat any animal, but it is very desirable for treating cats.

In an alternative embodiment, the method of killing insects is carried out such that the spot-on composition is applied in a volume sufficient to deliver a dosage of the active neonicotinoid component in an amount ranging from between about 0.1 mg/kg to about 40 mg/kg of host animal body weight. In a preferred embodiment, the dose of neonicotinoid ranges from about 2 mg/kg to about 20 mg/kg of host animal body weight. In a more preferred embodiment, the spot-on composition application comprises a volume sufficient to deliver a neonicotinoid dose ranging from about 5 mg/kg to about 15 mg/kg of host animal weight.

In another embodiment, the method of killing insects is carried out such that the spot-on composition is applied in a volume sufficient to deliver a dosage of the active pyrethroid component ranging from about 0.1 mg/kg to about 40 mg/kg of host animal body weight. In a preferred embodiment, the dose of pyrethroid ranges from about 0.5 mg/kg to about 20 mg/kg of host animal body weight. In a more preferred embodiment, the spot-on composition application comprises a volume sufficient to deliver a pyrethroid dose ranging from about 0.5 mg/kg to about 10 mg/kg of host animal body weight.

In a further embodiment, the method of killing insects is carried out such that the spot-on composition further comprises an IGR, and is applied in a volume sufficient to deliver a dosage of the insect growth regulating active component ranging from about 0.1 mg/kg to about 40 mg/kg of host animal body weight. In a preferred embodiment, the dose of insect growth regulator ranges from about 0.2 mg/kg to about 20 mg/kg of host animal body weight. In a more preferred embodiment, the spot-on composition application comprises a volume sufficient to deliver an insect growth regulator dose ranging from about 0.5 mg/kg to about 10 mg/kg of host animal body weight.

One of skill in the art will understand that the dosage ranges provided above are approximate values that may vary within a broad range. The variance in dose is due to the fact that, in practice, the spot-on composition will be administered in defined doses and volumes to animals within a certain range of weights. As a result, the dosage actually applied to the animal may vary by a factor ranging from 0.1 to 10 relative to the preferred dose, without imparting any additional risks pertaining to toxicity or decreased efficacy.

Although the components of the composition are effective against a wide variety of pests and parasites, the composition is especially developed for the treatment of fleas (including the Ctenocephalides species) and ticks (the Rhipecephalus, Ixodes, and Trichodectes species). Furthermore, the frequency of application may be varied according to the needs of the individual animal, as well as the severity of infestation. The treatment of fleas may be repeated as often as once weekly, or may be reserved for one-time acute treatments of flea infestation or flare-ups. In one embodiment of the current invention, the treatment of fleas may be repeated about every four weeks, five weeks, or six weeks. In another embodiment, the spot-on composition is applied to the host animal for a one-time treatment of the pest infestation. With regard to the treatment of ticks, the application schedule for the spot-on composition will vary depending on the type of tick being treated. It is generally recommended that treatment of paralytic ticks (Ixodes species) occur more frequently than other species. In an embodiment of the current invention, paralytic ticks are treated at a frequency ranging from one to four weeks, with treatment every two weeks being preferred. Other genera of ticks generally have a treatment schedule similar to treatment of flea infestation, preferably ranging from approximately four to six weeks. In another embodiment, the spot-on composition is applied on a one-time basis for the treatment of tick infestation.

Although the invention described herein is susceptible to various modifications and alternative iterations, specific embodiments thereof have been described in greater detail above. It should be understood, however, that the detailed description of the spot-on composition is not intended to limit the invention to the specific embodiments disclosed. Rather, it should be understood that the invention is intended to cover all modifications, equivalents, and alternatives falling within the spirit and scope of the invention as defined by the claim language.

### Definitions

As used herein, the terms “about” and “approximately” designate that a value is within a statistically meaningful range. Such a range can be typically within 20%, more typically still within 10%, and even more typically within 5% of a given value or range. The allowable variation encompassed by the terms “about” and “approximately” depends on the particular system under study and can be readily appreciated by one of ordinary skill in the art.

As used herein, the term “w/w” designates the phrase “by weight” and is used to describe the concentration of a particular substance in a mixture or solution.

As used herein, the term “mL/kg” designates milliliters of composition per kilogram of body weight.

As used herein, the term “a.i.” designates active ingredient.

As used herein, the term “treatment” or “treating” of a condition, such as pest infestation, includes inhibiting an existing condition or arresting its development; or ameliorating or causing regression of the condition. The term “preventing” or “prevention” of a condition, such as insect or pest infestation, includes substantially blocking or inhibiting the development or growth of a condition before it starts. Compositions that treat or prevent infestations herein will preferably exhibit at least 90% efficacy.

As used herein, the term “pesticide” or “pesticidal” refers to an agent or a composition comprising an agent that is capable of preventing, reducing or eliminating pest infestations. Pesticides of the present invention generally include a neonicotinoid and a pyrethroid. Preferably, the pesticides of the present invention comprise imidacloprid and cyphenothrin, or imidacloprid and etofenprox.

As used herein, the term “insect growth regulator” or “IGR” refers to an agent that is capable of interrupting or inhibiting the life cycle of a pest such that the pest never matures into an adult and becomes incapable of reproducing. Preferred IGRs of the present invention include S-methoprene, pyriproxyfen and novaluron.

As used herein, the term “animal” refers to a mammal, specifically a companion animal, including but not limited to dogs, cats, rabbits, ferrets, horses, and hamsters.

As used herein, the term “pest” and “insect” refers to any ectoparasite, including but not limited to fleas, ticks, flies, keds, mosquitoes, and mites.

The following examples are intended to further illustrate and explain the present invention. The invention, therefore, should not be limited to any of the details in these examples.

### EXAMPLE 1

### An Imidacloprid/Cyphenothrin/S-methoprene Spot-On Pesticide Composition for Dogs

A spot-on pesticide composition can be made in accordance with the formulation provided in Table 1:

TABLE 1
Spot-On Pesticide Composition Comprising
Imidacloprid, Cyphenothrin, and S-methoprene

| Ingredient | Amount for 1000 L | Concentration (%) |
|---|---|---|
| Imidacloprid (98.3%) | 95.8 | 9.58 |
| Cyphenothrin (94.4%) | 54.0 | 5.40 |
| S-methoprene (95.5%) | 123.6 | 12.36 |
| Tocopherol Nicotinate | 50.0 | 5.00 |
| N-methylpyrrolidone | 355.0 | 35.50 |
| Ethylhexyl acetate | 271.0 | 27.10 |
| BHT | 1.0 | 0.10 |
| Diethylene glycol | 50.0 | 5.00 |
| monoethyl ether | | |
| TOTAL | 1000.0 | 100.00 |

Charge the diethylene glycol monoethyl ether, N-methylpyrrolidone, ethylhexyl acetate, BHT, and tocopherol nicotinate to a vessel and heat the contents to a temperature of 50° C. (about 1 hour). Once heated, charge the imidacloprid, cyphenothrin, and S-methoprene to the vessel and mix all components until a homogenous solution is formed (about 1 hour).

### EXAMPLE 2

### An Imidacloprid/Cyphenothrin/S-methoprene Spot-On Pesticide Composition for Dogs

A spot-on pesticide composition can be made in accordance with the formulation provided in Table 2:

TABLE 2
Spot-On Pesticide Composition Comprising
Imidacloprid, Cyphenothrin, and S-Methoprene

| Ingredient | Amount for 1000 L | Concentration (%) |
|---|---|---|
| Imidacloprid (98.3%) | 95.8 | 9.58 |
| Cyphenothrin (94.4%) | 54.0 | 5.40 |
| S-methoprene (95.5%) | 123.6 | 12.36 |
| Tocopherol Nicotinate | 50.0 | 5.00 |
| N-methylpyrrolidone | 355.0 | 35.50 |
| Phosphex 390 | 271.0 | 27.10 |
| BHT | 1.0 | 0.10 |
| Diethylene glycol | 50.0 | 5.00 |
| monoethyl ether | | |
| TOTAL | 1000.0 | 100.00 |

Charge the diethylene glycol monoethyl ether, BHT, Phosphex 390, N-methylpyrrolidone, and tocopherol nicotinate to a vessel and heat to a temperature of 50° C. (about 1 hour). Once heated, charge the imidacloprid, cyphenothrin, and S-methoprene to the vessel and mix all components until a homogenous solution is formed (about 1 hour).

### EXAMPLE 3

### An Imidacloprid/Cyphenothrin/S-methoprene Pesticide Composition for Dogs

A pesticide composition can be made in accordance with the formulation provided in Table 3:

TABLE 3
Spot-On Pesticide Composition Comprising
Imidacloprid, Cyphenothrin, and S-methoprene

| Ingredient | Amount for 1000 L | Concentration (%) |
|---|---|---|
| Imidacloprid (98.3%) | 95.8 | 9.58 |
| Cyphenothrin (94.4%) | 54.0 | 5.40 |
| S-methoprene (95.5%) | 123.6 | 12.36 |
| Tocopherol Nicotinate | 50.0 | 5.00 |
| Ethylhexyl acetate | 271.0 | 27.10 |
| BHT | 1.0 | 0.10 |
| DMSO | 355.0 | 35.5 |
| Diethylene glycol | 50.0 | 5.0 |
| monoethyl ether | | |
| TOTAL | 1000.0 | 100.00 |

Charge the diethylene glycol monoethyl ether, DMSO, BHT, ethylhexyl acetate, and tocopherol nicotinate to a vessel and heat to a temperature of 50° C. (about 1 hour). Once heated, charge the imidacloprid, cyphenothrin, and S-methoprene to the vessel and mix all components until a homogenous solution is formed (about 1 hour).

### EXAMPLE 4

### An Imidacloprid/Cyphenothrin Spot-On Pesticide Composition for Dogs

A pesticide composition can be made in accordance with the formulation provided in Table 4:

TABLE 4
Spot-On Pesticide Composition Comprising
Imidacloprid and Cyphenothrin

| Ingredient | Amount for 1000 L | Concentration (%) |
|---|---|---|
| Imidacloprid (98.3%) | 95.8 | 9.58 |
| Cyphenothrin (94.4%) | 54.0 | 5.40 |
| Tocopherol Nicotinate | 50.0 | 5.00 |
| Ethylhexyl acetate | 271.0 | 27.10 |
| BHT | 1.0 | 0.10 |
| N-methylpyrrolidone | 355.0 | 35.5 |
| Diethylene glycol | 50.0 | 5.0 |
| monoethyl ether | | |
| Phosphex 390 | 123.0 | 12.3 |
| TOTAL | 1000.0 | 100.00 |

Charge the diethylene glycol monoethyl ether, Phosphex 390, N-methylpyrrolidone, BHT, ethylhexyl acetate, and tocopherol nicotinate to a vessel and heat to a temperature of 50° C. (about 1 hour). Once heated, charge the imidacloprid and cyphenothrin to the vessel and mix all components until a homogenous solution is formed (about 1 hour).

### EXAMPLE 5

### An Imidacloprid/Cyphenothrin Spot-On Pesticide Composition for Dogs

A pesticide composition can be made in accordance with the formulation provided in Table 5:

TABLE 5
Spot-On Pesticide Composition Comprising
Imidacloprid and Cyphenothrin

| Ingredient | Amount for 1000 L | Concentration (%) |
|---|---|---|
| Imidacloprid (98.3%) | 95.8 | 9.58 |
| Cyphenothrin (94.4%) | 54.0 | 5.40 |
| Tocopherol Nicotinate | 50.0 | 5.00 |
| N-octylpyrrolidone | 50.0 | 5.0 |
| N-decylpyrrolidone | 100.0 | 10.0 |
| BHT | 1.0 | 0.10 |
| Ethylhexyl acetate | 271.0 | 27.1 |
| N-methylpyrrolidone | 205.0 | 20.5 |
| Diethylene glycol | 50.0 | 5.0 |
| monoethyl ether | | |
| Phosphex 390 | 123.0 | 12.3 |
| TOTAL | 1000.0 | 100.00 |

Charge the diethylene glycol monoethyl ether, Phosphex 390, N-methylpyrrolidone, BHT, ethylhexyl acetate, and tocopherol nicotinate to a vessel and heat to a temperature of 50° C. (about 1 hour). Once heated, charge the imidacloprid and cyphenothrin to the vessel and mix all components until a homogenous solution is formed (about 1 hour).

### EXAMPLE 6

### An Imidacloprid/Cyphenothrin Spot-On Pesticide Composition for Dogs

A pesticide composition can be made in accordance with the formulation provided in Table 6:

TABLE 6
Spot-On Pesticide Composition Comprising
Imidacloprid and Cyphenothrin

| Ingredient | Amount for 1000 L | Concentration (%) |
|---|---|---|
| Imidacloprid (98.3%) | 95.8 | 9.58 |
| Cyphenothrin (94.4%) | 54.0 | 5.40 |
| Tocopherol Nicotinate | 50.0 | 5.00 |
| Ethylhexyl acetate | 394.0 | 39.40 |
| BHT | 1.0 | 0.10 |
| N-methylpyrrolidone | 355.0 | 35.5 |
| Diethylene glycol | 50.0 | 5.0 |
| monoethyl ether | | |
| TOTAL | 1000.0 | 100.00 |

Charge the diethylene glycol monoethyl ether, N-methylpyrrolidone, BHT, ethylhexyl acetate, and tocopherol nicotinate to a vessel and heat to a temperature of 50° C. (about 1 hour). Once heated, charge the imidacloprid and cyphenothrin to the vessel and mix all components until a homogenous solution is formed (about 1 hour).

### EXAMPLE 7

### An Imidacloprid/Etofenprox/S-methoprene Spot-On Pesticide Composition for Cats

A pesticide composition can be made in accordance with the formulation provided in Table 7:

TABLE 7
Spot-On Pesticide Composition Comprising
Imidacloprid, Etofenprox, and S-methoprene

| Ingredient | Amount for 1000 L | Concentration (%) |
|---|---|---|
| Imidacloprid (98.3%) | 95.8 | 9.58 |
| Etofenprox | 150.0 | 15.00 |
| S-methoprene | 123.6 | 12.36 |
| Tocopherol Nicotinate | 50.0 | 5.00 |
| Ethylhexyl acetate | 175.0 | 17.50 |
| BHT | 1.0 | 0.10 |
| N-methylpyrrolidone | 355.0 | 35.5 |
| Diethylene glycol | 50.0 | 5.0 |
| monoethyl ether | | |
| TOTAL | 1000.0 | 100.00 |

Charge the diethylene glycol monoethyl ether, N-methylpyrrolidone, BHT, ethylhexyl acetate, and tocopherol nicotinate to a vessel and heat to a temperature of 50° C. (about 1 hour). Once heated, charge the imidacloprid, etofenprox, and S-methoprene to the vessel and mix all components until a homogenous solution is formed (about 1 hour).

### EXAMPLE 8

### An Imidacloprid/Etofenprox/S-methoprene Spot-On Pesticide Composition for Cats

A pesticide composition can be made in accordance with the formulation provided in Table 8:

TABLE 8
Spot-On Pesticide Composition Comprising
Imidacloprid, Etofenprox, and S-methoprene

| Ingredient | Amount for 1000 L | Concentration (%) |
|---|---|---|
| Imidacloprid (98.3%) | 95.8 | 9.58 |
| Etofenprox | 150.0 | 15.00 |
| S-methoprene | 123.6 | 12.36 |
| Tocopherol Nicotinate | 50.0 | 5.00 |
| Ethylhexyl acetate | 175.0 | 17.5 |
| N-octylpyrrolidone | 50.0 | 5.00 |
| N-decylpyrrolidone | 100.0 | 10.0 |
| BHT | 1.0 | 0.10 |
| N-methylpyrrolidone | 355.0 | 35.5 |
| Diethylene glycol | 50.0 | 5.0 |
| monoethyl ether | | |
| TOTAL | 1000.0 | 100.00 |

Charge the diethylene glycol monoethyl ether, N-methylpyrrolidone, N-octylpyrrolidone, N-decylpyrrolidone, BHT, ethylhexyl acetate, and tocopherol nicotinate to a vessel and heat to a temperature of 50° C. (about 1 hour). Once heated, charge the imidacloprid, etofenprox, and S-methoprene to the vessel and mix all components until a homogenous solution is formed (about 1 hour).

### EXAMPLE 9

### An Imidacloprid/Etofenprox/S-methoprene Spot-On Pesticide Composition for Cats

A pesticide composition can be made in accordance with the formulation provided in Table 9:

TABLE 9
Spot-On Pesticide Composition Comprising
Imidacloprid, Etofenprox, and S-methoprene

| Ingredient | Amount for 1000 L | Concentration (%) |
|---|---|---|
| Imidacloprid (98.3%) | 95.8 | 9.58 |
| Etofenprox | 150.0 | 15.00 |
| S-methoprene | 123.6 | 12.36 |
| Tocopherol Nicotinate | 50.0 | 5.00 |
| Ethylhexyl acetate | 175.0 | 17.5 |
| DSMO | 355.0 | 35.5 |
| BHT | 1.0 | 0.10 |
| Diethylene glycol | 50.0 | 5.0 |
| monoethyl ether | | |
| TOTAL | 1000.0 | 100.00 |

Charge the diethylene glycol monoethyl ether, DSMO, BHT, ethylhexyl acetate, and tocopherol nicotinate to a vessel and heat to a temperature of 50° C. (about 1 hour). Once heated, charge the imidacloprid, etofenprox, and S-methoprene to the vessel and mix all components until a homogenous solution is formed (about 1 hour).

### EXAMPLE 10

### An Imidacloprid/Etofenprox Spot-On Pesticide Composition for Cats

A pesticide composition can be made in accordance with the formulation provided in Table 10:

TABLE 10
Spot-On Pesticide Composition Comprising
Imidacloprid and Etofenprox

| Ingredient | Amount for 1000 L | Concentration (%) |
|---|---|---|
| Imidacloprid (98.3%) | 95.8 | 9.58 |
| Etofenprox | 150.0 | 15.00 |
| Tocopherol Nicotinate | 50.0 | 5.00 |
| Ethylhexyl acetate | 298.0 | 29.8 |
| DSMO | 355.0 | 35.5 |
| BHT | 1.0 | 0.10 |
| Diethylene glycol | 50.0 | 5.0 |
| monoethyl ether | | |
| TOTAL | 1000.0 | 100.00 |

Charge the diethylene glycol monoethyl ether, DSMO, BHT, ethylhexyl acetate, and tocopherol nicotinate to a vessel and heat to a temperature of 50° C. (about 1 hour). Once heated, charge the imidacloprid, etofenprox, and S-methoprene to the vessel and mix all components until a homogenous solution is formed (about 1 hour).

### EXAMPLE 11

### Efficacy Evaluation of a Spot-On Composition Containing Imidacloprid and Cyphenothrin for the Treatment of Fleas and Ticks on Dogs

The spot-on composition prepared in accordance with the present invention will exhibit greater than 95% efficacy against fleas and ticks when applied to an animal.

### EXAMPLE 12

### Efficacy Evaluation of a Spot-On Composition Containing Imidacloprid and Etofenprox for the Treatment of Fleas and Ticks on Dogs

The spot-on composition prepared in accordance with the present invention will exhibit greater than 95% efficacy against fleas and ticks when applied to an animal.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the following claims.

1. A spot-on pesticide composition comprising between about 1% and about 20% (w/w) of a neonicotinoid, between about 1% and about 20% (w/w) of a pyrethroid, and between about 40% and about 90% (w/w) of an organic solvent.

2. The spot-on pesticide composition of claim 1, wherein the composition comprises between about 5% to about 15% (w/w) of a neonicotinoid and between about 2% to about 18% (w/w) of a pyrethroid.

3. (canceled)

4. The spot-on pesticide composition of claim 1, wherein the neonicotinoid is selected from the group consisting of imidacloprid, acetamiprid, nithiazine, thiamethoxam, dinotefuran, nitenpyram, thiacloprid, and clothianadin.

5. The spot-on pesticide composition of claim 4, wherein the neonicotinoid is imidacloprid.

6. (canceled)

7. The spot-on pesticide composition of claim 1, wherein the pyrethroid is selected from the group consisting of permethrin, cypermethrin, cyphenothrin, etofenprox, fenvalerate, and cyfluthrin.

8. The spot-on pesticide composition of claim 7, wherein the pyrethroid is cyphenothrin or etofenprox.

9. (canceled)

10. (canceled)

11. (canceled)

12. (canceled)

13. (canceled)

14. (canceled)

15. The spot-on pesticide composition of claim 1, wherein the organic solvent is selected from the group consisting of acetyltributyl citrate, fatty acid esters, diisobutyl adipate, acetone, acetonitrile, benzyl alcohol, butyl diglycol, dimethylacetamide, dimethylformamide, dipropylene glycol n-butyl ether, ethanol, isopropanol, methanol, ethylene glycol monoethyl ether, ethylene glycol monomethyl ether, diethylene glycol monoethyl ether, monomethylacetamide, dipropylene glycol monomethyl ether, liquid polyoxyethylene glycols, propylene glycol, 2-pyrrolidones, ethylhexyl acetate, DSMO, Phosphex 390, diethylene glycol monoethyl ether, ethylene glycol, diethyl phthalate, ethoxydiglycol, and combinations thereof.

16. (canceled)

17. The spot-on pesticide composition of claim 1, wherein the composition further comprises between about 1% and about 10% (w/w) of an antioxidant.

18. (canceled)

19. (canceled)

20. The spot-on pesticide composition of claim 17, wherein the antioxidant is a vitamin E compound.

21. The spot-on pesticide composition of claim 20, wherein the antioxidant is selected from the group consisting of tocopherol acetate, tocopherol linoleate, tocopherol nicotinate, tocopherol succinate, ascorbyl tocopherol phosphate, dioleyl tocopherol methylsilanol, tocophersolan, tocopherol linoleate/oleate, and combinations thereof.

22. The spot-on pesticide composition of claim 17, wherein the antioxidant is tocopherol nicotinate.

23. The spot-on pesticide composition of claim 1, wherein the composition further comprises between about 0.1% and about 20% (w/w) of an insect growth regulator.

24. (canceled)

25. A spot-on pesticide composition comprising between about 1% and about 20% (w/w) of a neonicotinoid, between about 1% and about 20% (w/w) of a pyrethroid, between about 0.1% and about 20% (w/w) of an insect growth regulator, and between about 40% and about 90% (w/w) of an organic solvent.

26. (canceled)

27. (canceled)

28. (canceled)

29. (canceled)

30. (canceled)

31. (canceled)

32. (canceled)

33. (canceled)

34. A method of killing insect and pest pupae and adults on an animal, which method comprises: administering a localized cutaneous application between the shoulders of the animal, a spot-on pesticide composition comprising about 1% and about 20% (w/w) of a neonicotinoid, between about 1% and about 20% (w/w) of a pyrethroid, and between about 40% and about 90% (w/w) of an organic solvent, wherein the composition is administered in a volume sufficient to deliver a dosage of neonicotinoid and pyrethroid to the animal of an amount ranging from between about 0.1 mg/kg to about 40 mg/kg of animal weight, and wherein at least 90% efficacy against insect and pest pupae is achieved through administration of the composition to the animal.

35. The method of claim 34, wherein the application is made as a one-time treatment.

36. The method of claim 34, wherein the application is made every six weeks.

37. The method of claim 34, wherein the application is made every five weeks.

38. The method of claim 34, wherein the application is made every four weeks.

39. The method of claim 34, wherein the application is made every week.

40. The method of claim 34, wherein the animal is a mammal.

41. The method of claim 40, wherein the mammal comprises a dog or a cat.

42. The method of claim 34, wherein the spot-on pesticide composition additionally comprises between about 1% and about 10% (w/w) of an antioxidant.

43. The method of claim 34, wherein at least 95% efficacy is achieved.

44. The method of claim 34, wherein the spot-on pesticide composition additionally comprises between about 0.1% and about 20% (w/w) of an insect growth regulator.
